(19) United States
(12) Patent Application Publication
(10) Pub. No.: US 2004/0139808 A1
(43) Pub. Date: Jul. 22, 2004

(54) Micro force gages and calibration weights

(76) Inventor: Christopher Guild Keller, El Cerrito, CA (US)

Correspondence Address: CHRISTOPHER GUILD KELLER, 905 POMONA AVENUE, EL CERRITO, CA, 94530, US

(21) Appl. No.: 10/755,181

(22) Filed: Jan. 9, 2004

Related U.S. Application Data
(60) Provisional application No. 60/439,915, filed on Jan. 13, 2003.

(51) Int. Cl. G01L 1/00; G01L 5/00

(52) U.S. Cl. 73/862.381

(57) ABSTRACT

The invention is a microfabricated silicon cantilever with a stiffness appropriate to resolve forces of interest in working with micro objects. Stiffnesses may range from about 10 piconewtons per micron of deflection, to about 1 millinewton per micron of deflection. There is a set of micro weights of appropriate masses that is used to calibrate the force gages. The weights are captive to a ring on a handle so that they are free to move, but will not get lost.

This patent application claims the benefit of Provisional Patent Application No. 60/439,915 filed on Jan. 13, 2003.

### BACKGROUND

1. Field of Invention

The field of invention is devices for the measurement of forces of magnitude ranging from about 1 piconewton to about 10 millinewtons, and the dead weights needed to calibrate them.

2. Discussion of Prior Art

Precision force gauges on the macroscale are calibrated with dead weights that are traceable to standard precision weights by the National Institute of Standards and Technology. Prior art microscale force gauges are calibrated indirectly by measuring their resonance frequencies, and calculating their stiffness. The margin of error is high. Microfabricated cantilevers of the prior art for measuring forces are all made with the bending axis parallel to the plane of the silicon wafer. This restricts the geometry of the tip that engages the specimen to a simple column or pyramid shape.

### OBJECTS AND ADVANTAGES

The objects of the present invention are to make microfabricated single crystal silicon cantilever force gauges, and single crystal silicon microweights to calibrate them. No indirect measurements or calucluations are needed, so the reliability of the calibration is maximized. The bending axis of the high aspect ratio cantilevers is perpendicular to the plane of the silicon wafer, so the geometry of the tip can be any shape needed to engage the specimen to be studied. The deflection of the cantilever lies in a plane that is parallel to the microscope slide (or other substrate), and the height is thin (typically less than 50 micrometers) so it can fit under the high magnification objective. This means that the deflection of the gauge can be directly and conveniently measured in an optical microscope. Example applications that have been demonstrated include (1) pushing on individual living cells to measure their force of adhesion to various biomaterials, (2) pulling on bacterial fibers to measure forces that they exert, (3) measuring the output force of a microfabricated electrostatic actuator.

### DESCRIPTION OF DRAWINGS

FIG. 1: Plan view of embodiment with attached scale

FIG. 2: Plan view of device of FIG. 1 when subjected to an applied force to be measured

FIG. 3: Perspective view of a cantilever

FIG. 4: Side view of device in use under a microscope objective lens

FIG. 5: Close-up perspective view of device in use above the objective lens of an inverted microscope

FIG. 6: Plan view of embodiment without attached scale

FIG. 7: Plan view of a microweight for calibration

FIG. 8: Perspective view of a microweight for calibration

FIG. 9: Side view showing a calibration weight positioned above a cantilever to be calibrated

FIG. 10: Side view showing a calibration weight supported solely by the cantilever beam that is being calibrated.

FIG. 11: example embodiments of tip geometry

FIG. 12: embodiment for bi-directional force measurement

### LIST OF REFERENCE NUMERALS

2: force gauge

4: cantilever

6: rigid beam

8: curve to match cantilever shape when deflected to left rigid stop

10: antistiction bump

12: pointer

14: scale

16: pointer

18: tip to engage specimen

20: rigid arm to reach around scale

22: rigid arm to support scale

24: truss element

60: left rigid stop

64: base

66: handle

68: micropositioner

70: microscope objective lens

80: force gauge embodiment not having a scale

82: reference point from which to measure deflection

84: tip to engage specimen

86: cantilever

100: microweight

102: retaining ring of weight

104: junction between retaining ring of weight and legs that straddle the gage tip

106: interior space of retaining ring

107: weight legs that straddle the gage tip

108: flared entrance to guide weight onto gage tip

110: retaining ring of handle

112: gate to let the ring of the weight engage the ring of the handle

114: microhandle beam

116: macroscale handle

150: embodiment for bi-directional force measurement

152: cantilever on embodiment for bi-directional force measurement

160: straight tip

162: bent tip

Summary:

The invention is a microfabricated silicon cantilever with a stiffness appropriate to resolve forces of interest in working with micro objects. Stiffnesses may range from about 10 piconewtons per micron of deflection, to about 1 millinewton per micron of deflection. There is a set of micro weights of appropriate masses that is used to calibrate the force gages. The weights are captive to a ring on a handle so that they are free to move, but will not get lost.

### DESCRIPTION OF THE INVENTION

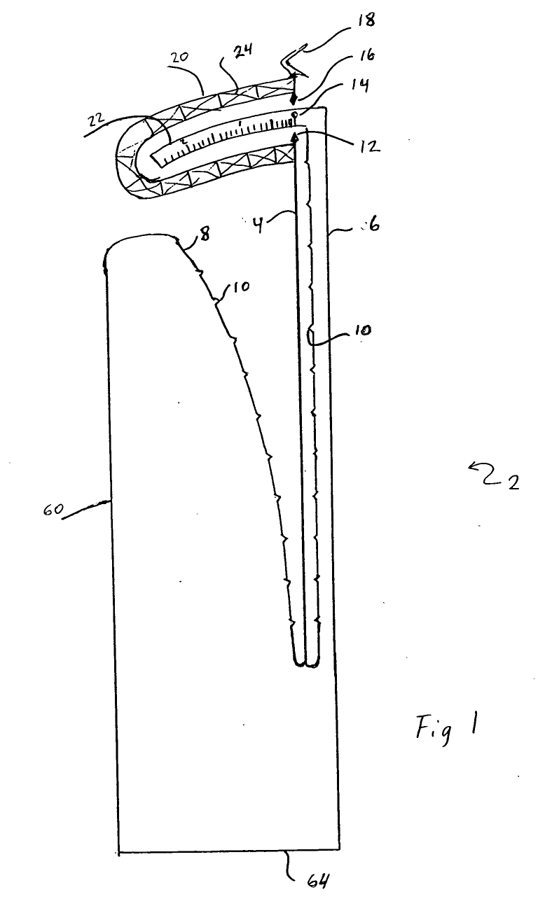

FIG. 1 shows one embodiment of the force gage (2). The force sensitive part is the elastic cantilever (4). When a force is pushing or pulling on the tip (18) of the gage, the cantilever (4) will deflect by an amount proportional to the magnitude of the force. The amount of deflection can be read on the graduated scale (14) using either pointer (12) or (16). A rigid connecting arm (20) goes around the graduated scale support structure (22) to rigidly connect tip (18) to the end of the cantilever. To make the connecting beam 20 rigid but as light weight as possible, it is not solid but is comprised of an open trusswork of thin beams (24). The cantilever (4) is protected from being hit by objects to by rigid bar 3 and the other rigid protective side (60). The curved edge (8) is designed to match the curve of the deflected cantilever at the maximum allowed deflection. The anti-stiction bumps (10) minimize the contact area confronting the cantilever if a liquid is present to cause capillary forces that would act to make the cantileveer stick to the side of either (6) or (8). The gage can be mounted onto many kinds of handles or supports, depending on what is needed for a given application. Typically the base portion (64) of the gage will be bonded to a handle (66 of FIG. 4) (e.g., using silver epoxy, or reflowed glass frit).

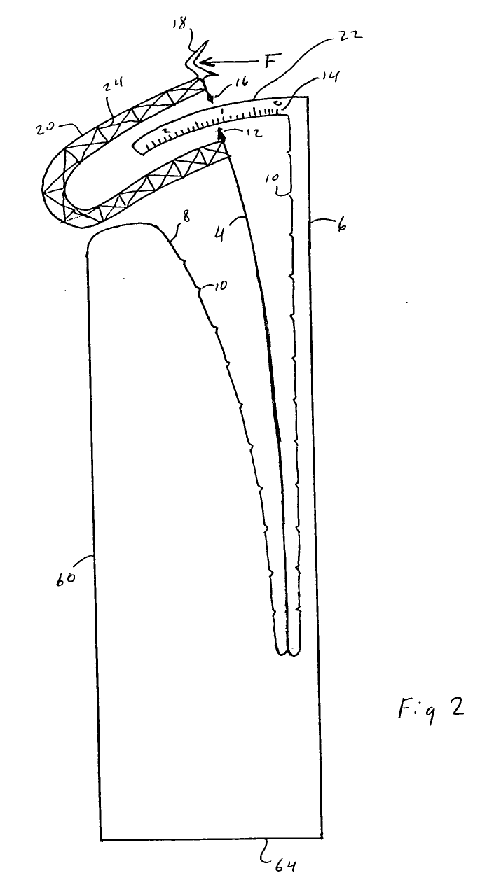

FIG. 2 shows the gage of FIG. 1 as it would look in a deflected state being acted on at the tip by a force F. Notice that the curve of the scale (14) and scale support (22) are designed to match the pathway of motion traced out by pointers (12) and (16) as the cantilever (2) is deflected. Therefore the pointers maintain a close separation (e.g., 10 to 30 microns) away from the scale, but never contact it over the full range of travel. Also the connecting beam (10) and side (30) are designed to never contact each other in normal use of the gage. The precise shape of this curve can be obtained by calculation, or by actual measurements of a large scale model. For cantilevers that are tapered along their length and radiused at their base to minimize stress concentrations, is it best to make measurements from large scale models made of an elastic material such as plexiglass.

The elastic cantilever (4) is a high aspect ratio structure. That is, the height (perpendicular to the plane of the drawing) of the beam is much greater than the width (in the direction of bending) of the beam. This minimizes the out of plane deflection of the cantilever. It is important to keep the cantilever and tip moving only within the plane of the device, with no significant out of plane deflection.

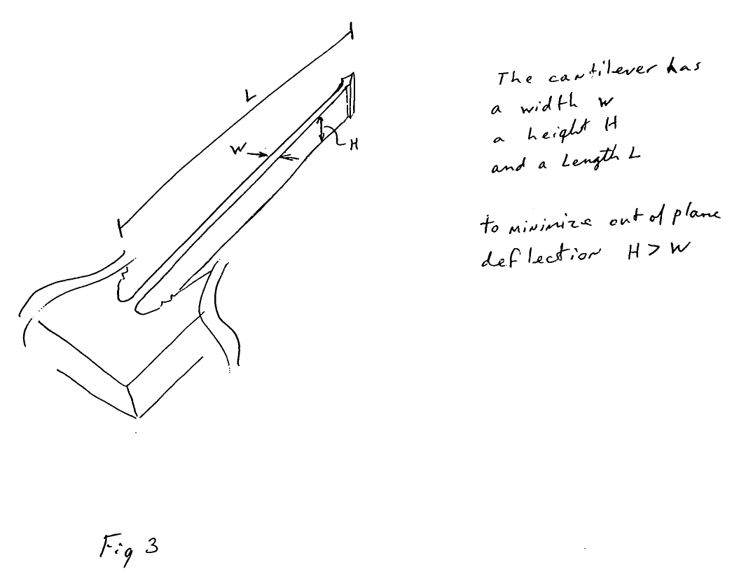

FIG. 3 shows the dimensions of the cantilever. Example dimensions (all in microns) that have been made include: (W, H, L): (0.1, 30, 1500); (1, 40, 1500); (0.3, 20, 1000); (25, 40, 1500)

The stiffness increases with the cube of the width, and the stiffness decreases with the cube of the length for cantilevers of constant cross section. To minimize stress concentrations the cantilever width should be appropriately tapered and radiused where it joins rigid members.

Referring to FIG. 1, the length of the scale (14) can be shorter (e.g., 100 microns long) if it is desired to trade off a smaller measurement range for a small gage that may be needed to fit in constrained space. (in that case the curved arm 20 can be made shorter too, and the width of the whole gage footprint can be decreased.

FIG. 4a shows a typical mounting strategy with a 1 mm diameter stainless steel wire (41) with one end bonded to the force gage, and the other end clamped into the arm of a micropositioning system (usually a commercially available x-y-z stage of some sort). The deflection of the gage as it pushes against a specimen can be read by looking through the microscope. FIG. 4B shows an inverted microscope situation, and a close up of the handle at the end boned to the gage.

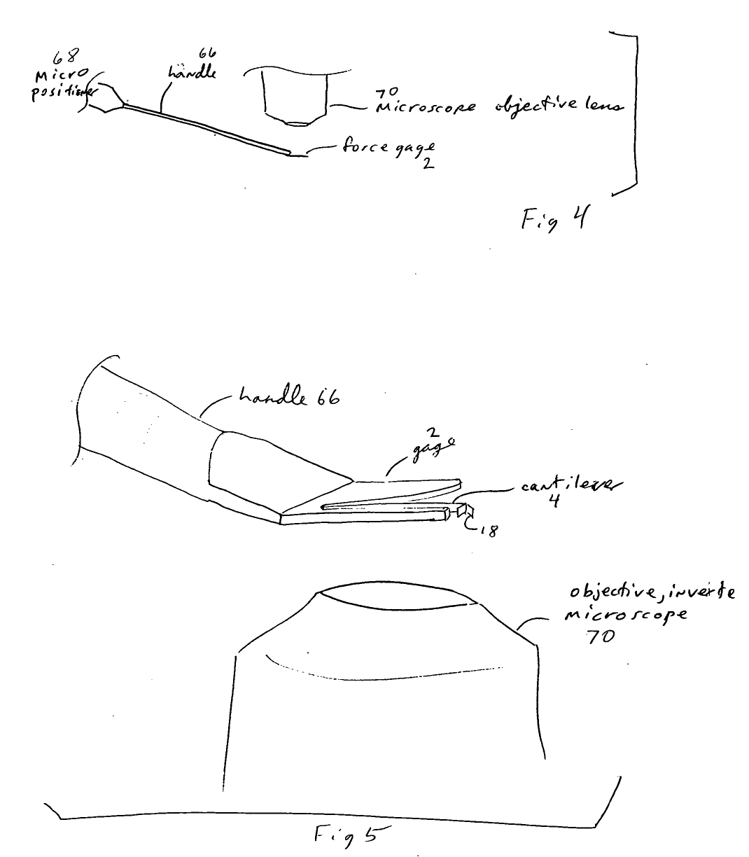

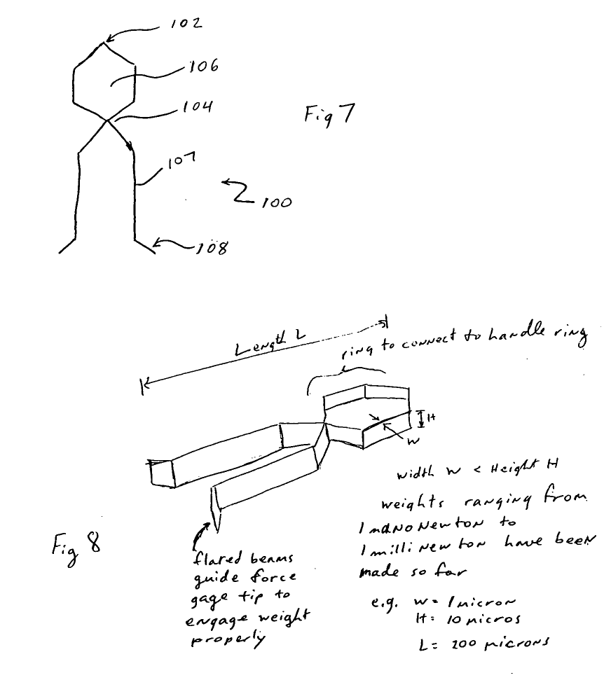

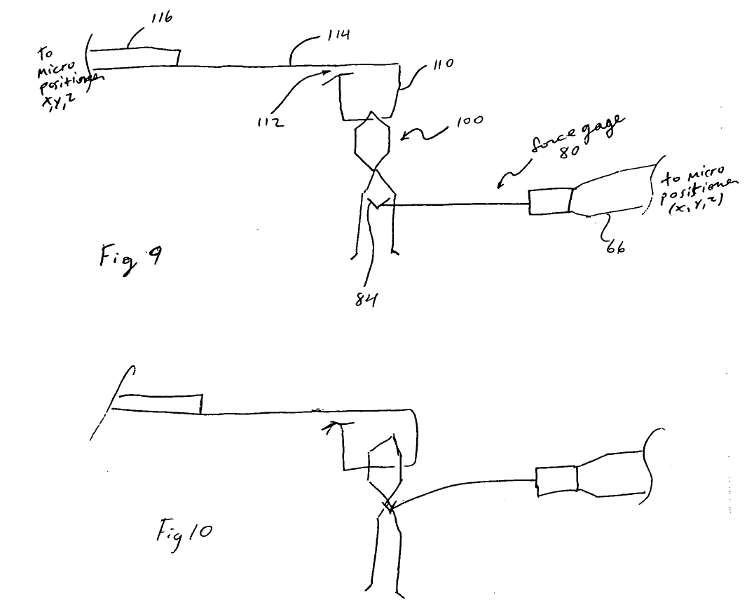

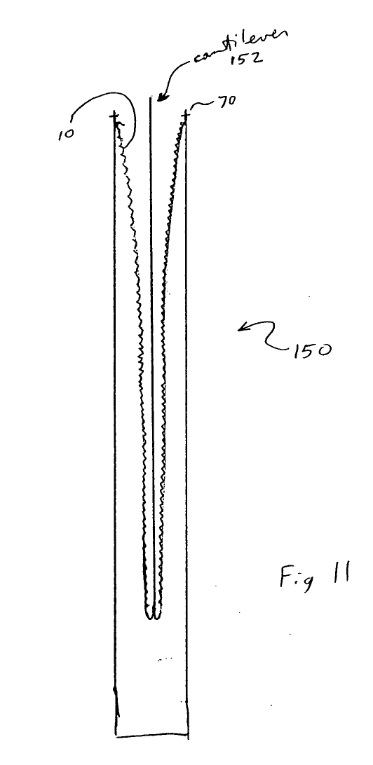

FIG. 5 shows a single crystal silicon weight to be used for calibrating force gages. A problem with microweights is that they are easily lost. FIGS. 7-10 show how this weight design allows it to be used, but still remain captive at all times to a micro handle structure (114) and macro handle (116). At the time of manufacture, the weight is assembled onto the micro handle (114) by passing beam (102) through the constricted pathway (112) so that it becomes captive to the ring (110). The weight is not likely to find its way back out through pathway (112). To ensure that the weight never comes off, a small drop of epoxy or other glue can be used to close off pathway (112). In FIG. 9 the weight is entirely supported by the ring (110) at the end of the micro handle (114). In FIG. 10 the weight is entirely supported by the force gage. The ring (110) of the handle (114) is not touching the weight at any point. Therefore by measuring the deflection of the force gage cantilever in going from the unloaded state in FIG. 9 to the loaded state in FIG. 10, due to the known weight, the stiffness of the force gage can be calculated. To make these observations, it is convenient to have a microscope mounted so that its optical axis is horizontal. The handle (116) is typically a 1 mm diameter stainless steel wire which can be mounted on a micropositioner so that the microweight (100) can be held at the focal point of the objective lens of the horizontal microscope. The handle of the force gage is mounted in another micropositioner so that it can be moved independently, and also located at the focal point of the microscope. Using the micropositioner holding the weight, it is possible to set the weight on the gage. The deflection of the gage can be read by a calibrated reticle in one of the microscope's eyepieces. After this is read, another weight can be set on the gage. In this way a range of data points are acquired that spans the range of force of interest. If the force gage is one of the designs with a built in graduated scale, then the calibration would be done by reading the cantilever deflections with respect to that scale.

The microweight should be made of a material that will not change shape or mass over time. Silicon exposed to air quickly forms a native oxide layer, and is chemically inert thereafter. Silicon is covalently bonded and is not subject to plastic deformation or creep. By having a simple geometric shape, the mass of the weight can be determined by measuring its dimensions, calculating the volume, and then multiplying by the density. The density of single crystal silicon at any desired operating temperature is known to high accuracy. The thickness and density of the oxide film are also known. The value of the earth's gravitational field at the location of measurement must also be known. Finally, to correct for bouncy due to displaced air, the barometric pressure and temperature at the time of force calibration must be measured.

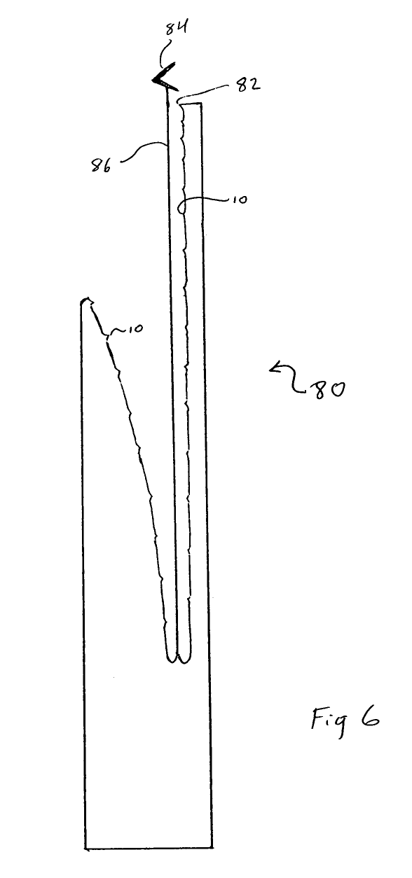

FIG. 6 shows a gage design with no graduated scale. Deflections are measured relative to a fixed point selected by the user on the adjacent rigid beam. The point (82) is one that could be used as a fixed reference. The measurement can also be done with an eyepiece reticle.

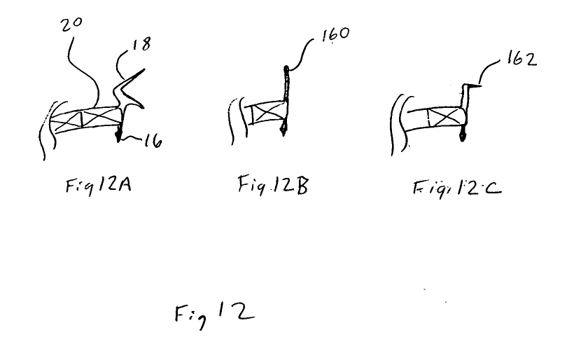

FIG. 11 shows an embodiment (150) in which the cantilever can be deflected in both directions, and rigid points (70) are available, located on the rigid side structures, to serve as references to measure any deflection of the cantilever.

FIG. 12 shows some other tip shapes. Of course there is no limit to the number of special tip shapes that could be made for all the possible special applications. FIG. 12A is a V tip, 12B shows a straight tip collinear with the cantilever, and FIG. 12C shows a sharp tip perpendicular to the cantilever. The tips can have special coatings or chemical functionalizations to adhere to particular specimens to be pulled on.

Operation of the Invention:

The tip of the force gage is brought into contact with the specimen. Further displacement causes a force to develop. This force is measured by observing the deflection of the cantilever that results. The deflection is measured by observing where the pointers (12, 16) are pointing on the scale (14).

The force gauge of FIG. 6 does not have a scale or pointer. Reading of this gauge requires an optical system such as a microscope with a calibrated measuring reticle in its eyepiece, or a digital TV camera with image analysis software that can measure the number of pixels associated with the displacement.

Method of Fabrication of the Invention:

1. clean silicon wafer

2. spin on photoresist (PR), pattern the PR, and hardbake

3. anisotropic etch silicon to produce vertical sidewalls (e.g., by the Bosch process in an STS etcher)

4. remove PR

5. grow 1 micron of thermal oxide (wet oxidation, 1000 C)

6. protect the patterned side and remove the oxide from the backside of the wafer using 5% HF (aqueous)

7. etch the exposed silicon in TMAH (25% by wt in water) at 60 C until the cantilevers are released, and are held to the wafer only by break away silicon tethers

8. grow thermal oxide (wet oxidation at 1000 C) to further thin the cantilevers

9. dissolve oxide in 5% HF

10. grip a cantilever by its base and break the silicon tethers that hold it to the wafer

11. rigidly bond (e.g., using reflowed glass frit, or silver epoxy) the base of the cantilever to a rigid handle or substrate suitable for the application.

12. calibrate the stiffness of the force gage cantilever by hanging known microweights on it and recording the resulting deflection.

What is claimed:

1. A microfabricated force gauge comprising a high aspect ratio cantilever having a rigid base at its proximal end, and a shaped tip at its distal end

2. the gauge of claim 1 having a rigid beam connecting the base to a scale, and having a rigid arm on the cantilever that extends around the scale, both scale and arm having a curved shape that permits deflection of the cantilever with no contact between scale and arm

3. the gauge of claim 2 having antistiction bumps on the rigid beam that connects the base to the scale

4. the gauge of claim 1 made of single crystal silicon

5. the gauge of claim 2 made of single crystal silicon

6. a microweight having a ring that is captively linked to another ring which is attached to a handle.

7. the microweight of claim 6 made of single crystal silicon
